(19) United States
(12) Patent Application Publication
(10) Pub. No.: US 2004/0010465 A1
(43) Pub. Date: Jan. 15, 2004

(54) Method and apparatus for exception based payment posting

(76) Inventors: Cliff Michalski, Madison, WI (US); Satyajit Puniani, San Marcos, CA (US); Nitin Jadhav, Madison, WI (US); Ryan Niemeyer, Madison, WI (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/442,028

(22) Filed: May 20, 2003

Related U.S. Application Data
(60) Provisional application No. 60/381,867, filed on May 20, 2002.

(51) Int. Cl. G06F 17/60

(52) U.S. Cl. 705/40

(57) ABSTRACT

A method of posting a payment from a payor comprises creating a payment record, identifying a set of charges to which the payment is applied to, comparing the set of charges to the payment record, and creating an exception record based on the payment record and the set of charges. Once a payment is posted a user is presented with an option to write-off the exception record. Alternatively, a user may also alter a set of charges applied to the account based on the exception record.

### CROSS-REFERENCE TO RELATED APPLICATIONS

This application claims priority to U.S. Provisional Application Serial No. 60/381,867, entitled, “An Exception-based Payment Posting Method with Ad Hoc Transaction Specificity for a Computerized Medical Insurance Premium Billing System,” filed May 20, 2002, the disclosure of which is hereby expressly incorporated herein by reference.

### TECHNICAL FIELD

The present patent relates generally to health insurance accounting, and more particularly, the present patent relates to a system and a method of recording premium payments by organizations that sell insurance, although it is equally applicable to any industry that receives periodic premium payments.

### BACKGROUND

Health insurance providers typically receive payments from multiple sources including employers and individuals in exchange for continuing insurance coverage for designated members. This situation gives rise to various conflicting needs.

For example, (1) client organizations require detailed accounting of variances between payments received and expected amounts, whether these variances result from additional coverage being purchased when new members are added to eligibility rolls, from less coverage purchased when some members are dropped from eligibility rolls, from changes in coverage levels by one or more individuals, from unexplained underpayment or overpayment, or from some other cause. Client organizations' financial policies, e.g., methods of handling overdue amounts, etc., often require that these variances including amounts still owed be aged separately from each other and from amounts subsequently billed. “Aging” in this context involves tracking initial due dates in relation to subsequent payments on a charge.

Similarly, (2) organizations issuing insurance handle large numbers of customers and they often need to retain records of all premium transactions indefinitely. For some organizations, this can exceed 250,000 individual transactions per month. Therefore insurance issuing organizations need a feasible method for fulfilling clients' needs identified above in (1) and at the same time ensure that they make efficient use of employee time.

Existing payment posting systems have failed to address at least some of these needs. Standard strategies used by existing payment systems include methods such as Simple payment posting, open-item posting, etc. In Simple payment posting, payment details are not recorded at the individual coverage level. With such a method, if the overall amount paid differs from the amount expected, then the variance for the entire received payment is noted, and the resultant balance can be forwarded to be dealt with until future payments are received. In open-item posting, payment details are recorded at the individual coverage level, i.e., the payment status of each line-item charge is recorded in the payment record.

Simple payment posting is inadequate to meet the actual needs described in (1) above. Even if information provided with the payment clearly indicates that the payment is targeted to some particular set of charges for enumerated coverage for the most recent payment period, simple payment posting allows users no way to mark the targeted charges as paid in full while leaving open other transactions. There are also a number of other inflexibilities in existing Simple payment posting solutions.

On the other hand, since open-item posting requires manual entry of each portion of the payment received at the coverage level, it does not allow for efficient use of employees' time, which is essential for large organizations as described above in (2). While the information provided with the payment may clearly indicate in one sentence which set of charges is targeted by the payment, a user posting the payment has to address each open charge record for the account, or at least for the invoice, individually.

In some cases, accurate open-item posting may not even be possible, for instance, when part of the variance in the payment received is unexplained by the payor. In such a case, some of the charges have likely been paid in full while some have not, but the user has no way of knowing which open charges to close, i.e., to mark as paid in full. There are also a number of other redundancies in existing open-item posting solutions.

### BRIEF DESCRIPTION OF THE DRAWINGS

The present patent is illustrated by way of example and not limitation in the accompanying figures, in which like references indicate similar elements, and in which:

FIG. 1 illustrates a block diagram of a basic entity relationship involved in a premium payment posting system.

FIG. 2 is an illustration of key elements in a billing data store and their relationships.

FIG. 3 illustrates a flowchart of an exemplary implementation of various processes involved in payment posting system.

FIG. 4 illustrates a flowchart of an exemplary implementation of a process involved in distributing payments received over sets of charges stored by the payment processing system.

FIG. 5 illustrates a flowchart of an exemplary implementation of a process involved in noting exceptions where received amounts do not match expected amounts.

FIG. 6 illustrates a data network including a first group of healthcare facilities adapted to implement the premium payment posting system.

FIG. 7 illustrates a schematic diagram of one embodiment of the network computer used in the data network.

FIG. 8 illustrates a schematic diagram of one possible embodiment of several components located in one or more healthcare facilities.

### DETAILED DESCRIPTION OF THE DRAWINGS

A method of posting a payment from a payor comprises creating a payment record, identifying a set of charges to which the payment is applied to, comparing the set of charges to the payment record, and creating an exception record based on the payment record and the set of charges. Once a payment is posted a user is presented with an option to write-off the exception record. Alternatively, a user may also alter a set of charges applied to the account based on the exception record.

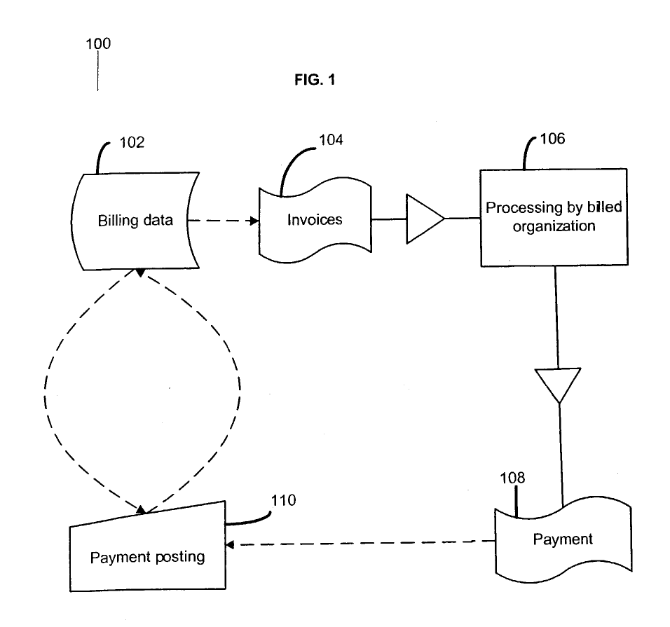

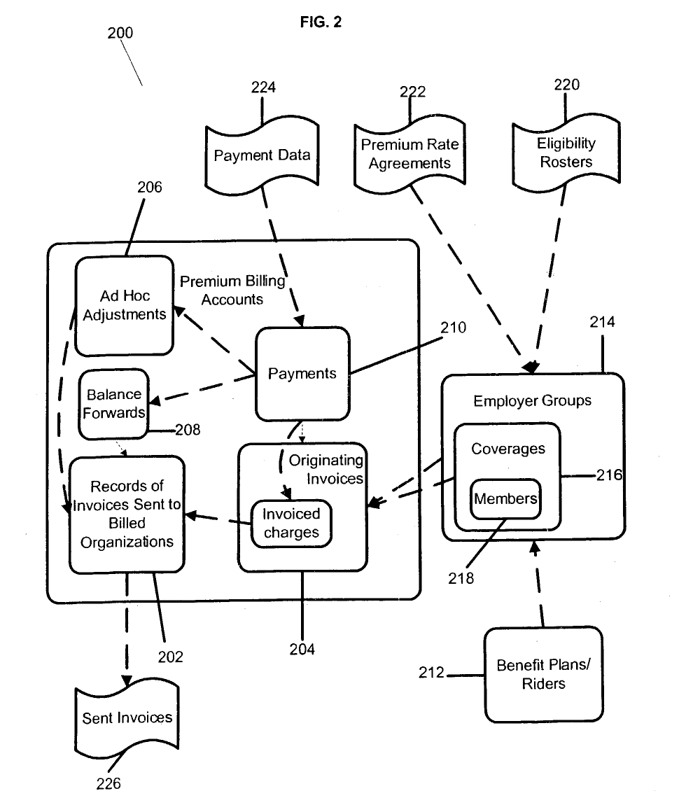

FIG. 1 illustrates a block diagram of a basic entity relationship involved in a premium payment posting system. Block 102 represents a billing data store that contains records of payment agreements and enrollment statistics from which amounts to be billed can be derived. The data store also contains records of past payments and balances forwarded from previous payments, including unpaid balances and overpayments. The relevant content of billing data store 102 is illustrated in further detail in FIG. 2.

Block 104 represents a premium invoice generated by an insurance provider based on the information contained in the billing data store 102. The invoice 104 is sent to a billed organization such as a client who is buying insurance coverage. As shown in block 106, the billed organization processes the invoice 104, based on the information it has regarding previous invoices, unpaid balances, overpayments, etc. Block 108 represents a premium payment sent by the billed organization 106 to the billing organization. Accompanying this payment 108, there may also be some statement called payment data that includes identifying numbers for the payment, a date, etc. Payment data typically includes payment targets, i.e., a characterization of the charges against which various portions of the payment are meant to apply. Payment data may also include explanations for variances between the amounts paid and the targeted charge amounts in the invoice 104.

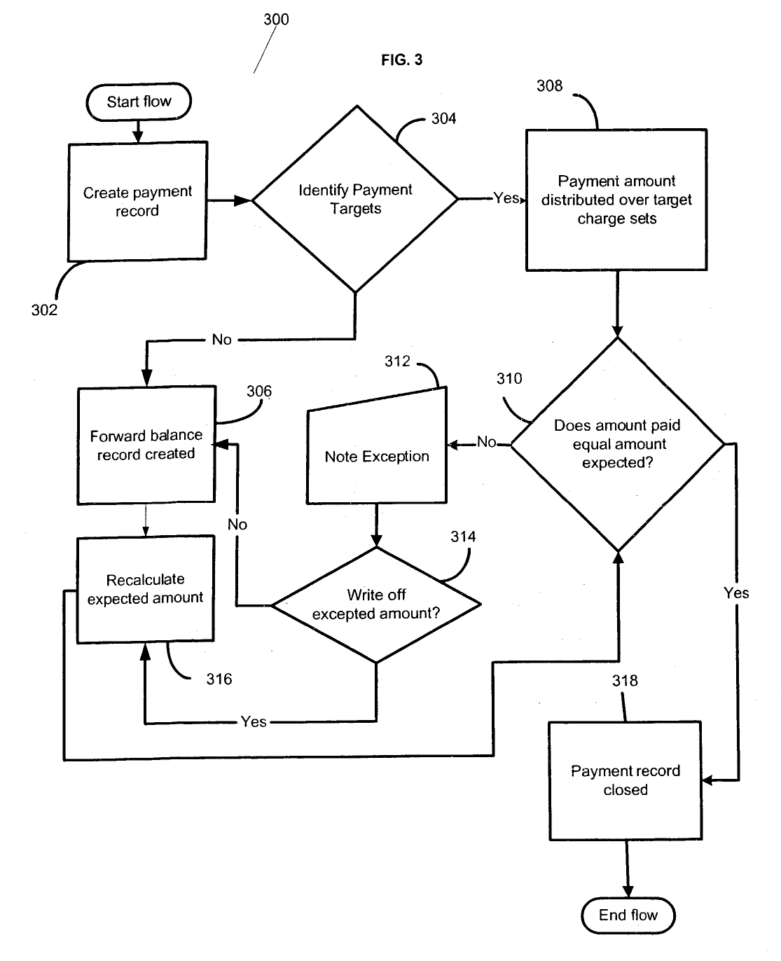

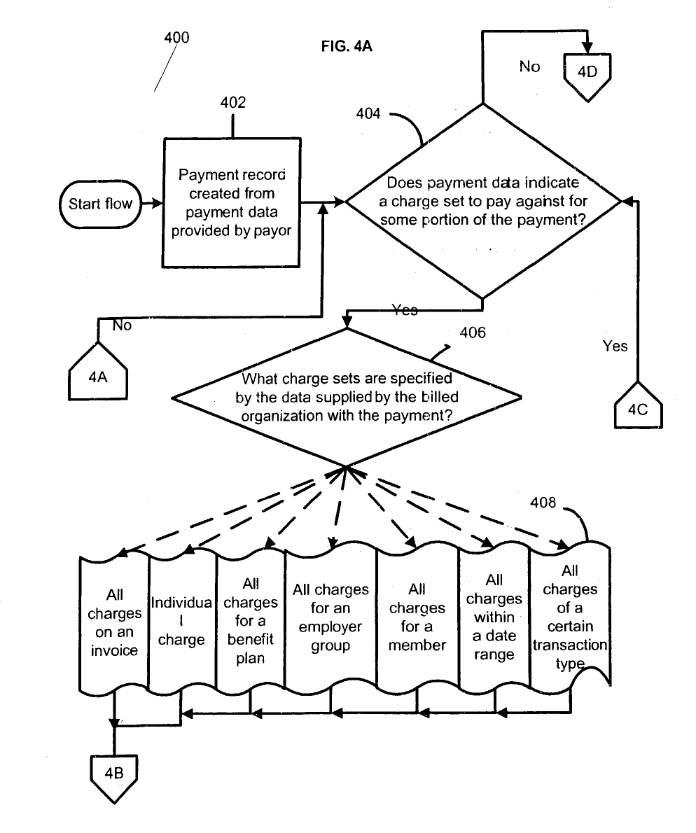

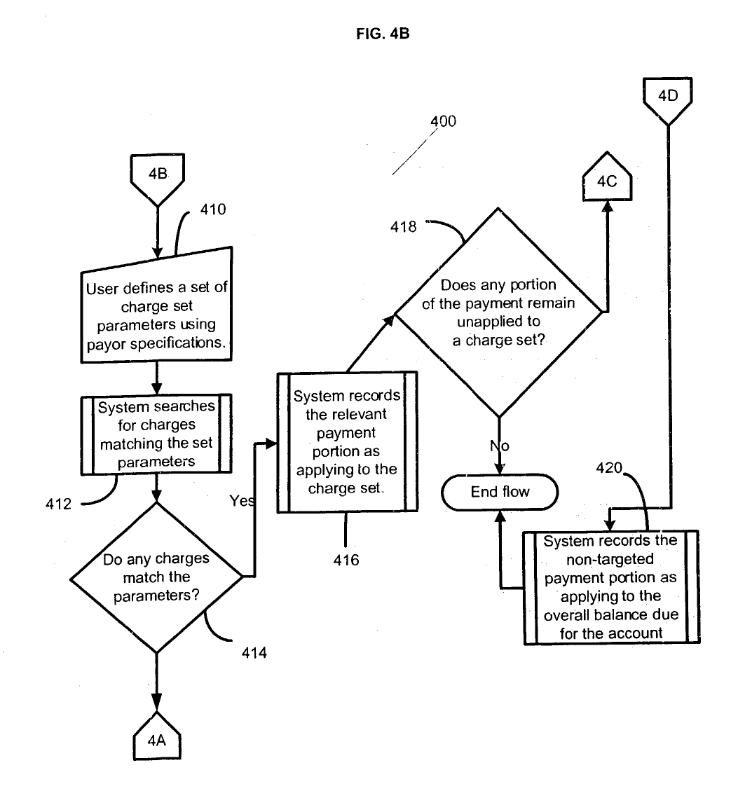

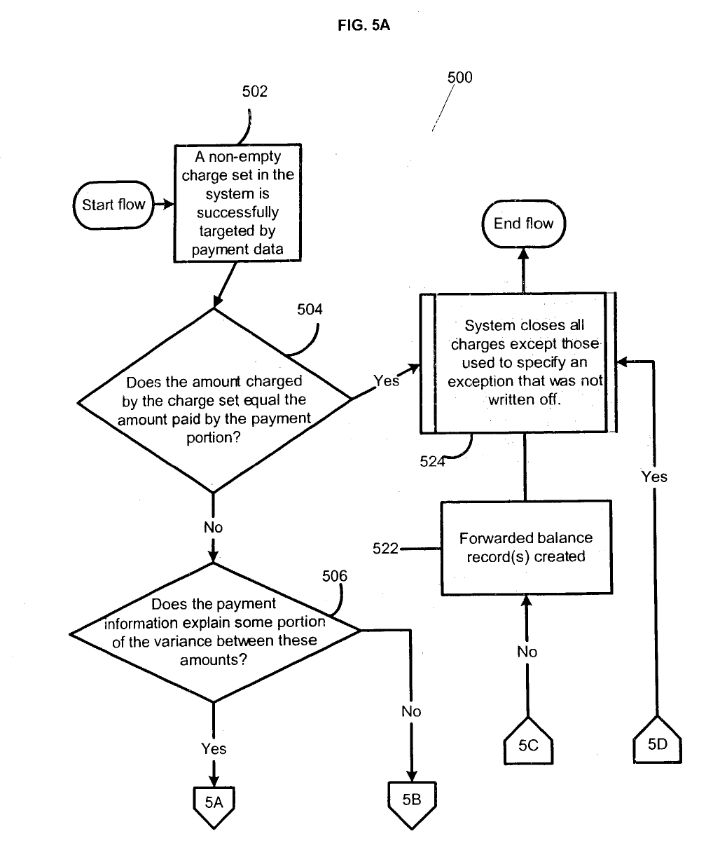

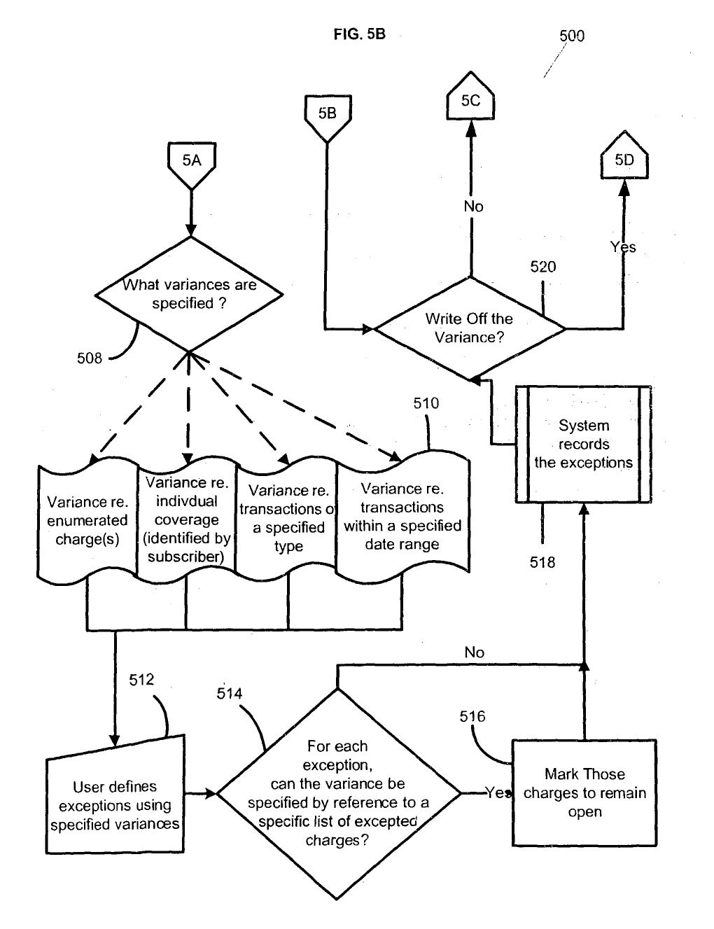

Once the premium payment 108 is received by the billing organization, a user compares the payment data received on the premium payment 108 with the billing data in the data store 102 to post the payment. This process of posting the premium payment is represented by block 110 in FIG. 1, and it is further described in FIG. 3, FIG. 4 and FIG. 5. The payment posting results in the creation of at least one new record in the billing data store 102, a payment record. The payment record contains various identifying information for the payment 108, e.g., check number, date received, and an account of the distribution of the payment over various charge sets in the invoice 104. If the amounts paid with the payment 108 differ from the amounts expected for the charge set(s) targeted by the payment 108, then additional records may be created in the billing data store 102 called balance forward records. Each balance forward record records an amount identified as still owed or as an overpaid amount. Balance forward records appear on subsequent invoices 104 for the billed organization until the owed amounts are paid off, written off, or, in the case of overpayment, until the overpayment is applied to some charges due for the billed organization or is written off.

FIG. 2 is an illustration of key elements in the billing data store 102 and their relationships. Please note that besides the relationships explained in FIG. 2, the data store 102 may contain an unlimited number of additional elements that play a role in generation of invoice 104. Likewise, each element identified in FIG. 2 may include more subdivisions and other content that are not indicated. The diagram in FIG. 2 also notes key relationships between elements in the data store 102 and entities external to the data store 102. For each organization billed for premium, data store 102 contains account records with information that includes demographic information, billing history, payment history, etc. Account records may also contain preferences regarding invoice formats and delivery schedules.

Block 202 represents records of invoices sent to billed organizations. Such billing records contain billing history within an account record organized by invoice records. Billing activity that may be captured in the billing records 202 may result from at least three sources: (1) premium billing charges from an originating invoice 204, (2) ad-hoc adjustments 206, and (3) balance forwards 208. Billing history of a billed organization contained in billing records 202 also contains a complete copy of each invoice 226 sent to the billed organization. Here each invoice 226 may contain charges originating on that invoice, balance forwards from previous payment posting activity and/or outstanding charges, and ad hoc adjustments applied to the account during payment posting.

Information about payments by the billed organizations is stored in the payment history 210. Payment history 210 includes a record for each payment including identifying information and payment target information, i.e., the characterization of charges on an invoice to which the payment is meant to apply. Additional payment data including time of payment, check number, etc., may be stored in payment data 224. A single payment may be distributed over multiple payment targets. Payments targets may be recorded at various levels of detail. Possible targets include groups of all outstanding charges on an originating invoice 204, an individual charge or enumeration of individual charges, all outstanding charges on an originating invoice associated with a particular benefit plan or coverage record, etc. The application of payments to payment targets is further explained in FIG. 4. As explained in FIG. 3 and FIG. 4, payment records are created and payments are targeted using payment data provided by the billed organization.

The balance forward record 208 may have various levels of detail associated with it depending on the circumstances of its creation. It may be associated with a particular outstanding charge, with a set of closed charges characterized by their association with a benefit plan, with an invoice, or with any of a combination of other records. The association of balance forward record 208 with other information in the billing history is further explained in FIG. 3, FIG. 4 and FIG. 5. The benefit offerings 212 are organized by employer groups 214. An employer group 214 is defined as a group of employer having insurance coverage with the same benefit offerings. The information about insurance coverage is represented by coverage record 216, where each coverage record includes a member record 218 for each covered individual with that insurance coverage. A coverage record 216 is typically identified by a subscriber name, where such subscriber name may or may not be a covered member. For example, a subscriber name may be an employee name where the covered member may be the spouse of the subscriber employee.

Regular updates regarding enrollment for insurance coverage is provided via eligibility rosters 220, supplied by billed organizations. Eligibility rosters 220 list enrollment during a billing period for each benefit option 212. These updates are propagated from employer group records 214 to individual insurance coverage of member records 218.

An originating invoice 204 draws on current enrollment information contained in the coverage records 216 and the premium rate agreement information 222 related to the employer group 214 to produce individual charge records for each insurance coverage active during the period billed by the invoice 204. Such individual charge records are sent by the originating invoice 204 to the records of invoices sent to billed organizations 202.

FIG. 3 illustrates a flowchart of an exemplary implementation of various processes involved in a payment posting system. As a first step in the process of payment posting, at 302, a user creates a payment record that includes data such as identifying number for the payment, the payment received date, total amount paid, etc. As shown per block 304, the user attempts to identify one or more charge sets in the system as payment targets to which he or she can post the total payment amount or portions of the payment amount. The process of identifying payment targets and matching them with received payments is further explained in FIG. 4.

If, for some portion of the payment, no non-empty set of charges in the system can be identified as a payment target, then a forward balance record 208 is created at 306. The forward balance record 208 represents an amount that is applied against the balance of the premium billing account as a whole. The forward balance 208 will either be applied to the account as an unspecified credit or applied during future payment posting to some other charge set associated with the account. Users can partition excess payments and attach comments to characterize the intended targets of some portion(s) of payment in cases where the stated target does not correspond with any charges present in the system. Once a forward balance record 208 is created, the system recalculates the expected amount of the target charge sets 316.

On the other hand, at 304 if a non-empty charge set in the system is successfully identified to match a payment portion, the payment portion is distributed over the identified target charge sets 308. At 310, the system evaluates whether the amount paid is equal to the amount expected for any of the identified target charge sets for each targeted charge set. If a deviation between the expected amount for a charge set and the payment portion is detected, this deviation is noted. At 312 the user can declare all or part of the deviation as an “exception,” thereby creating a new record to be tracked by the system. An unlimited number of exceptions can be noted for any one deviation. The process of noting exceptions is further explained in FIG. 5.

For each exception, the user can attach an explanation, e.g., a link to a coverage record with a note on a change in rate for that coverage, and choose to write off that amount at 314 to create a balance forward record 208 for that amount 306. The creation of such a balance forward record 208 allows the system to age overdue receivables, i.e., to track the degree to which the amount represented by each balance forward record 208 is overdue. After noting an exception, whether the system creates a balance forward record 208 as per 306 or not, the system recalculates the expected amount of the target charge sets 316. At this point the process of evaluating whether the amount paid is equal to the amount expected for any of the identified target charge sets for each targeted charge set is repeated at 310.

When all variances between the payment amount and amount expected by the identified target charge set have been removed, the payment record is closed at 318.

FIG. 4A and FIG. 4B (referred to hereinafter as FIG. 4) illustrate a flowchart of an exemplary implementation of a process 400 involved in distributing payments received over sets of charges stored by the payment processing system. Such sets of charges are also referred to here as payment target charges. At 402, upon receipt of a payment from a payor, the system creates a payment record. The payment from a payor may include payment data that may indicate a set of charges for which the entire amount is to apply. Alternatively the payment may indicate more than one charge set to which the payment amount is to apply, and indicate the amount of the payment that is to be applied to each charge set. In an alternate case the payment may indicate one or more charge set to which some specified portion(s) of the payment is to be applied, without indicating any charge set to which the remainder of the payment is to be applied. In another case, the payment may not indicate any charge set to which the payment is to be applied at all. At 404, the user determines if the payment data indicate a charge set to which some portion of the payment is to be applied.

If the user determines that the payment data indicate a charge set to which some portion of the payment is to be applied, at 406, the user identifies what charge sets are specified by the payment data. 408 illustrates some alternate set of targets to which the payment needs to be applied as per payor's instructions. Users may define charge sets using combinations and exclusions based on several characteristics, including all of those listed in the diagram at 408. For example, the payor may have specified that all payment is to be applied to a set of charges that fall within a certain date range, or that a portion of the payment is to be applied to all charges for a specified benefit plan. The manner in which sets of charges are defined in received payment data may vary widely.

Based on the instruction to select the charge sets as target payment, the user defines a set of charge set parameters at 410. The system provides a set of options for defining charge sets employing as many characteristics as are available in the system that could fruitfully be used to classify charges, so as to afford users the maximum flexibility in accurately targeting payment portions according to payment data specifications. A user can define a charge set as per payor instructions by specifying a combination of characteristics that will identify the target charge set. For example, if the payor has specified that a payment should be applied to all charges within a given date range, the user can select appropriate dates as the defining parameters to select the set of target charges that fall within this date range. Alternatively, a second combination of the same characteristics may be used to define charges that are to be excluded from the charge set to which a payment is to be applied. For example, if the payor instruction is to apply a payment to all charges related to all benefit plans other than benefit Plan A, the system allows the user to select parameters to define a charge set that excludes charges related to benefit Plan A.

Once the user defines a set of parameters to define a charge set as per payor instructions, at 412 the system performs a search for charges in the defined class. At 414 the system determines if it has found any charges that match the parameters set by the user. If the system does not find any charge sets that match the parameters set by the user, the control transfers back to 404, where the user has to select an alternate criteria for selecting target charge sets. However, if the system finds any charge set that matches the parameters set by the user, at 416 the system records the relevant payment portion as applying to this charge set.

Once a portion of the payment is applied to a set of charges, at 418 the system evaluates if there is any other portion of the payment that remains unapplied to any charge sets. If there is any portion of the payment unapplied to any charge set, again the control transfers back to 404 where the user has to select another criteria for selecting target charge sets to which the remaining portion of the payment is to be applied. If at 404, the user finds that there are no more charge sets to which the remaining portion of the payment is to be applied, at 420 the system records the non-targeted portion of the payment as applying to the overall balance due for the account.

FIG. 5A and FIG. 5B (referred to hereinafter as FIG. 5) illustrate a flowchart of an exemplary implementation of a process 500 involved in noting exceptions where received amounts do not match expected amounts. At 502 a non-empty charge set in the system is successfully targeted by the payment data. At 504, for every targeted charge set, the system compares the total amount charged to the payment amount. If these amounts match for each targeted charge set, the system closes all charges and the exception noting process ends at 524.

However, if at 504 the total amount charged as per the targeted charge set does not match to the payment amount, the user looks at the payment data to see if the payor has given any explanation as to why the total amount charged as per the targeted charge set does not match the payment amount, as shown by 506. If there is some explanation for such a discrepancy, at 508 the user looks at what are the variances specified in the payment data that explains this discrepancy. The user may derive these explanations from the payment information supplied by the billed organization. For instance, a billed organization may provide an enumerated list of individual charges explaining the variance in payment for each charge, or it could characterize a payment variance from the expected amount as per the target charge set by claiming a discount for all transactions in that charge set over a certain date range. Since the payment information may provide such explanation with varying levels of specificity, the system allows users to specify the exceptions at different levels of specificity as well. 510 lists various sources from which the user may derive the explanation of such variances.

Once the user selects an explanation for a variance from either the payment data or from any other sources, at 512 the user declares an exception using specified variances. To declare an exception is to specify a portion of the variance and include a comment as to why the variance occurred. Once an exception is declared at 512 using specified variances, for each exception, at 514 the user determines if the variance can be specified by reference to a specific list of expected charges. If a match is found between a variance and a specific expected charge, this charge is marked to remain open, as shown at 516, before the system records the exception at 518.

If at 506, the user finds that the payment data does not explain some portion of the variance between the total amount charged and the payment amount, at 520 the user may decide if for the unexplained variance he or she should write-off the balance. Similarly, once the system records an exception at 518, at 520 it allows the user to decide if for the exception he or she should write-off the balance. If at 520, the user decides to write-off the balance, at 524 the system closes all charges except for those used to specify an exception that was not written off. However, if at 520 the user decides not to write-off the balance, at 522 the system creates a balance forward record 208 before it closes all the charges at 524. A different balance forward record 208 is created for each exception declared. This allows the system to track overdue amounts separately, even when the charges in question have been carried over from the same payment posting session.

A balance forward record 208 may or may not retain an association with the relevant charge set. For instance, if an exception is specified by saying “The charge for X coverage originating on Y invoice was underpaid by Z dollars because of a coverage change for that subscriber,” then the exception can be specified by listing that particular charge. However, if the paying organization is less specific about where the variance occurred or if its explanation refers to charges not yet in the system, e.g., coverage just added but not yet indicated on eligibility rosters 220, then the exception does not retain a link to existing system records. To say that a link is retained means that the associated charges are considered outstanding. In this case the consequent balance forward 208 is regarded by the system and reported on invoices as being a continuance of those original charges. In the case of an underpayment not explained to a level of detail to allow its association with an enumerated list of charges, the system does not have enough information to consider the balance forward 208 to be a continuance of some original charges. Hence, these original charges are closed along with the paid charges.

When all variances have been noted, the payment record is closed and sent to the data store 102.

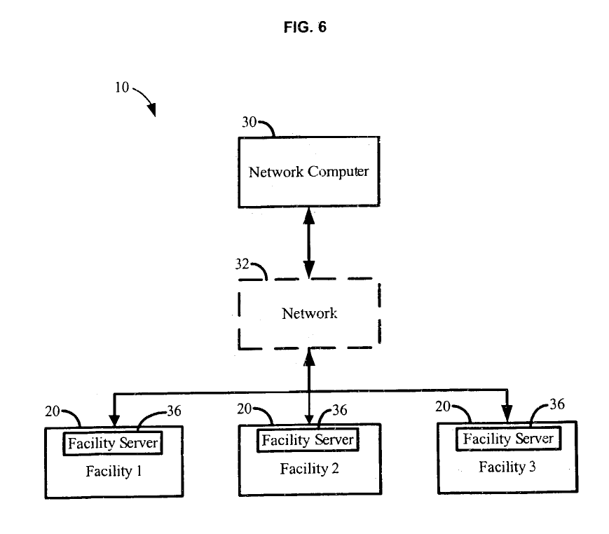

FIG. 6 illustrates a data network including a first group of healthcare facilities adapted to implement the premium payment posting system. Specifically, FIG. 6 illustrates an embodiment of a data network 10 including a first group of healthcare facilities 20 operatively coupled to a network computer 30 via a network 32. The plurality of healthcare facilities 20 may be located, by way of example rather than limitation, in separate geographic locations from each other, in different areas of the same city, or in different states. The network 32 may be provided using a wide variety of techniques well known to those skilled in the art for the transfer of electronic data. For example, the network 32 may comprise dedicated access lines, plain ordinary telephone lines, satellite links, combinations of these, etc. Additionally, the network 32 may include a plurality of network computers or server computers (not shown), each of which may be operatively interconnected in a known manner. Where the network 32 comprises the Internet, data communication may take place over the network 32 via an Internet communication protocol.

The network computer 30 may be a server computer of the type commonly employed in networking solutions. The network computer 30 may be used to accumulate, analyze, and download data relating to a healthcare facility's medical records. For example, the network computer 30 may periodically receive data from each of the healthcare facilities 20 indicative of information pertaining to a patient's medical record, billing information, employee data, etc. The healthcare facilities 20 may include one or more facility servers 36 that may be utilized to store information for a plurality of patients/employees/accounts/etc. associated with each facility.

Although the data network 10 is shown to include one network computer 30 and three healthcare facilities 20, it should be understood that different numbers of computers and healthcare facilities may be utilized. For example, the network 32 may include a plurality of network computers 30 and dozens of healthcare facilities 20, all of which may be interconnected via the network 32. According to the disclosed example, this configuration may provide several advantages, such as, for example, enabling near real time uploads and downloads of information as well as periodic uploads and downloads of information. This provides for a primary backup of all the information generated in the process of updating and accumulating healthcare data.

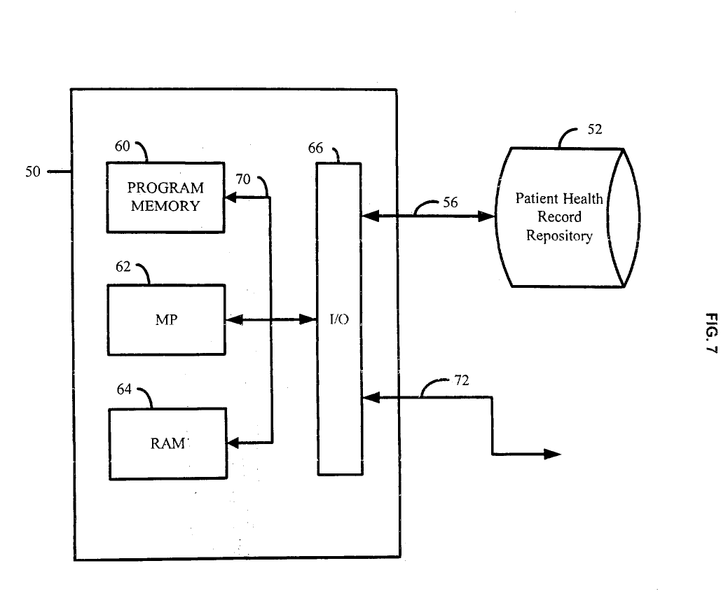

FIG. 7 is a schematic diagram of one possible embodiment of the network computer 30 shown in FIG. 6. The network computer 30 may have a controller 50 that is operatively connected to a database 52 via a link 56. It should be noted that, while not shown, additional databases may be linked to the controller 50 in a known manner.

The controller 50 may include a program memory 60, a microcontroller or a microprocessor (MP) 62, a random-access memory (RAM) 64, and an input/output (I/O) circuit 66, all of which may be interconnected via an address/data bus 70. It should be appreciated that although only one microprocessor 62 is shown, the controller 50 may include multiple microprocessors 62. Similarly, the memory of the controller 50 may include multiple RAMs 64 and multiple program memories 60. Although the I/O circuit 66 is shown as a single block, it should be appreciated that the I/O circuit 66 may include a number of different types of I/O circuits. The RAM(s) 64 and programs memories 60 may be implemented as semiconductor memories, magnetically readable memories, and/or optically readable memories, for example. The controller 50 may also be operatively connected to the network 32 via a link 72.

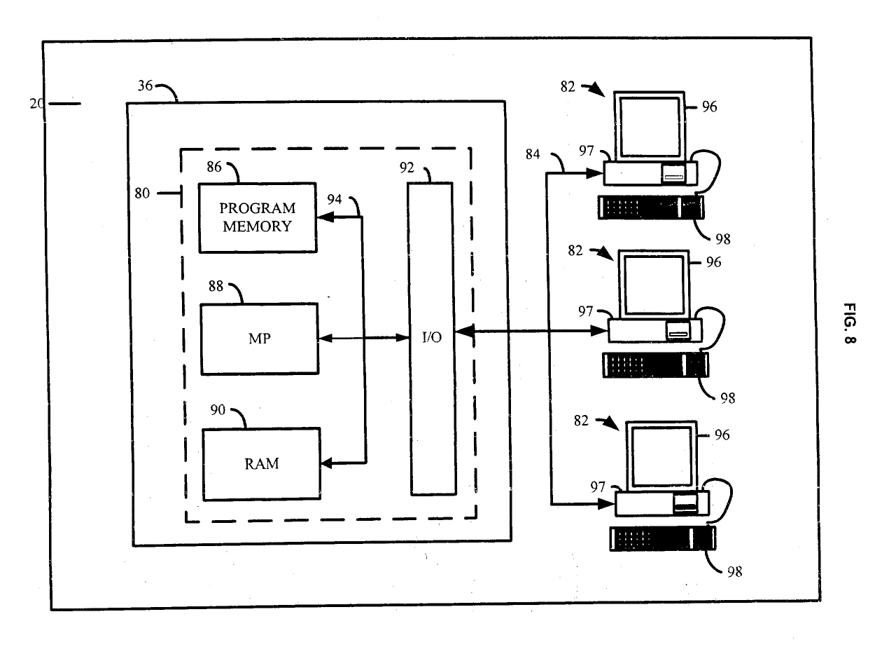

FIG. 8 is a schematic diagram of one possible embodiment of several components located in one or more of the healthcare facilities 20 from FIG. 6. Although the following description addresses the design of the healthcare facilities 20, it should be understood that the design of one or more of the healthcare facilities 20 may be different than the design of other healthcare facilities 20. Also, each healthcare facility 20 may have various different structures and methods of operation. It should also be understood that the embodiment shown in FIG. 8 illustrates some of the components and data connections present in a healthcare facility, however it does not illustrate all of the data connections present in a typical healthcare facility. For exemplary purposes, one design of a healthcare facility is described below, but it should be understood that numerous other designs may be utilized.

The healthcare facilities 20 may have a facility server 36, which includes a controller 80, wherein the facility server 36 is operatively connected to a plurality of client device terminals 82 via a network 84. The network 84 may be a wide area network (WAN), a local area network (LAN), or any other type of network readily known to those persons skilled in the art. The client device terminals 82 may also be operatively connected to the network computer 30 from FIG. 6 via the network 32.

Similar to the controller 50 from FIG. 7, the controller 80 may include a program memory 86, a microcontroller or a microprocessor (MP) 88, a random-access memory (RAM) 90, and an input/output (I/O) circuit 92, all of which may be interconnected via an address/data bus 94. As discussed with reference to the controller 50, it should be appreciated that although only one microprocessor 88 is shown, the controller 80 may include multiple microprocessors 88. Similarly, the memory of the controller 80 may include multiple RAMs 90 and multiple programs memories 86. Although the I/O circuit 92 is shown as a single block, the I/O circuit 92 may include a number of different types of I/O circuits. The RAM(s) 90 and programs memories 86 may also be implemented as semiconductor memories, magnetically readable memories, and/or optically readable memories, for example.

The client device terminals 82 may include a display 96, a controller 97, a keyboard 98 as well as a variety of other input/output devices (not shown) such as a printer, mouse, touch screen, track pad, track ball, isopoint, voice recognition system, etc. Each client device terminal 82 may be signed onto and occupied by a healthcare employee to assist them in performing their duties. Healthcare employees may sign onto a client device terminal 82 using any generically available technique, such as entering a user name and password. If a healthcare employee is required to sign onto a client device terminal 82, this information may be passed via the link 84 to the facility server 36, so that the controller 80 will be able to identify which healthcare employees are signed onto the system and which client device terminals 82 the employees are signed onto. This may be useful in monitoring the healthcare employees' productivity.

Typically, facility servers 36 store a plurality of files, programs, and other data for use by the client device terminals 82 and the network computer 30. One facility server 36 may handle requests for data from a large number of client device terminals 82. Accordingly, each facility server 36 may typically comprise a high end computer with a large storage capacity, one or more fast microprocessors, and one or more high speed network connections. Conversely, relative to a typical facility server 36, each client device terminal 82 may typically include less storage capacity, a single microprocessor, and a single network connection.

Although the premium payment posting system, as described herein, is preferably implemented in software, it may be implemented in hardware, firmware, etc., and may be implemented by any other processor associated with the healthcare facilities. Thus, the routine(s) described herein may be implemented in a standard multi-purpose CPU or on specifically designed hardware or firmware as desired. When implemented in software, the software routine(s) may be stored in any computer readable memory such as on a magnetic disk, a laser disk, or other storage medium, in a RAM or ROM of a computer or processor, etc. Likewise, the software may be delivered to a user or process control system via any known or desired delivery method including, for example, on a computer readable disk or other transportable computer storage mechanism or over a communication channel such as a telephone line, the Internet, etc. (which are viewed as being the same as or interchangeable with providing such software via transportable storage medium).

In the foregoing specification the present patent has been described with reference to specific embodiments. However, one of ordinary skill in the art will appreciate that various modifications and changes can be made to these embodiments without departing from the scope of the present patent as set forth in the claims below. Accordingly, the specification and figures are to be regarded in an illustrative rather than in a restrictive sense, and all such modifications are intended to be included within the scope of the present patent.

What is claimed is:

1. A method of posting a payment from a payor comprising:
creating a payment record;
identifying a set of charges to which the payment is applied to;
comparing the set of charges to the payment record; and
creating an exception record based on the payment record and the set of charges.

2. The method of claim 1, further comprising writing off the exception record.

3. The method of claim 2, further comprising adjusting the set of charges for an amount of the written-off exception record.

4. The method of claim 1, further comprising adding an explanation to the exception record.

5. The method of claim 4, further comprising storing the exception record for future processing.

6. The method of claim 5, further comprising reporting a part of the exception record on an invoice.

7. The method of claim 1, wherein identifying the set of charges includes:
selecting a set of criteria for identifying a target charge set based on an instruction given by the payor;
finding the target charge set using the selected set of criteria;
recording the target charge set as the set of charges.

8. The method of claim 1, wherein identifying the set of charges includes applying a non-targeted portion of the payment to an overall balance due on the payor's account.

9. The method of claim 1, wherein creating the exception record comprises:
recording an explanation provided by the payor with the payment explaining a portion of a variance between the payment and the identified set of charges;
determining the type of the portion of a variance using a list of variance types; and
recording the portion of variance and the type of the portion of a variance in the exception record.

10. The method of claim 9, further comprising writing off the portion of the variance.

11. The method of claim 9, further comprising creating a balance forward record without an association with the identified set of charges.

12. The method of claim 9, further comprising creating a balance forward record with an association with the identified set of charges.

13. The method of claim 12, further comprising reporting the balance forward record on an invoice.

14. A payment posting system used for posting a payment from a payor, comprising:
a record creating system adapted to create a payment record;
an identifier system adapted to identify a set of charges to which the payment is applied to;
a comparing system adapted to compare the identified set of charges to the payment record; and
an exception creating system adapted to create an exception record based on the payment record and the identified set of charges.

15. The payment posting system of claim 14, further adapted to write-off the exception record.

16. The payment posting system of claim 15, further adapted to adjust the identified set of charges for an amount of the written-off exception record.

17. The payment posting system of claim 14, further adapted to add an explanation to the exception record.

18. The payment posting system of claim 17, further adapted to store the exception record for future processing.

19. The payment posting system of claim 18, further adapted to report a part of the exception record on an invoice.

20. For use in a payment processing system used to post a payment from a payor, a computer program embodied in at least one computer readable medium comprising:
first software for creating a payment record;
second software for identifying a set of charges in the payment processing system to which the payment is applied to;
third software for comparing the identified set of charges to the payment record; and
fourth software for creating an exception record based on the payment record and the identified set of charges.

21. The computer program of claim 20, further comprising a fifth software for writing off the exception record.

22. The computer program of claim 21, wherein the fifth software is further adapted to adjusting the identified set of charges for an amount of the written-off exception record.

23. The computer program of claim 20, wherein the fourth software is further adapted to add an explanation to the exception record.

24. The computer software of claim 23, wherein the fourth software is further adapted to store the exception record for future processing.

25. The computer software of claim 24, further comprising a sixth software for reporting a part of the exception record on an invoice.

26. A computer device for use in a payment processing system used to post a payment from a payor, the computer device comprising:
first means for creating a payment record;
second means for identifying a set of charges in the payment processing system to which the payment is applied to;
third means for comparing the identified set of charges to the payment record; and
fourth means for creating an exception record based on the payment record and the identified set of charges.
